(19) United States
(12) Patent Application Publication
(10) Pub. No.: US 2006/0059517 A1
(43) Pub. Date: Mar. 16, 2006

(54) System and method for creating a play sequence for a radio or tv program

(75) Inventors: Eric Thelen, Aachen (DE); Andreas Kellner, Aachen (DE); Jan Kneissler, Aachen (DE); Holger R. Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,610

(22) PCT Filed: Dec. 1, 2003
(86) PCT No.: PCT/IB03/05637

§ 371 Date: Jun. 10, 2005

(30) Foreign Application Priority Data
Dec. 12, 2002 (EP) 02102742.0

(51) Int. Cl. H04N 5/445; H04N 7/16; G06F 13/00; G06F 3/00

(52) U.S. Cl. 725/46; 725/135

(57) ABSTRACT

A system and a method are described for generating sequences of audio or video contents (A . . . I). Contents (A . . . I) are available in a stored or otherwise readable form. Additional data (for example, genre, type, time, date, play time, costs, etc.) are provided together with the contents (A . . . I). While taking a user profile (P) into account, a play sequence (S) is composed from the contents (A . . . I), using selection means (20). By matching the additional data with selection criteria of the user profile (P), a content evaluation number is determined first. For play sequences of a plurality of contents (A . . . I), a sequence evaluation number is then determined, in which the content evaluation numbers of the contents (A . . . I) arranged therein and preferably also correlation values between the contents and/or costs for requesting the contents are taken into account. A sequence (S) is selected in accordance with its sequence evaluation number.

The invention relates to a system and a method for generating sequences of audio or video contents.

When making a radio program, some audio contents are selected from a plurality of available audio contents and composed to a play sequence. In a conventional radio transmitter, for example, this composition would be the task of an editor. The same task is performed when composing a TV program.

With the current and future technical possibilities of storing or accessing audio or video contents, and for transmitting these contents to a targeted audience of individual users or groups of users, the realization of “personal radio” or “personal TV” is possible in which a program with audio or video contents corresponding to the profile of interest of each user is transmitted to a user or a group of users. The composition of such a program, i.e. a play sequence, and its transmission to an appropriate end apparatus with the user will be a task of a service provider.

The concept of “radio on demand” is described in WO 99/39466, in which an individual radio program is generated for each listener. A profile with personal data and preferences is stored for a listener. Audio contents comprise manually determined additional data such as keywords to the contents, a compilation, a summary, a version number and playing time. By matching the additional information with the user profile, an individual program is composed and played back. When composing a program, a composite value is computed as a product for audio contents by multiplying a manually given intrinsic value of the audio content with a value of interest for the relevant theme, which value is stored in a user profile. A play sequence is generated in that audio contents are arranged in the sequence of the computed composite value.

The composition of a radio or TV program for a large number of users with different references stored in each user profile can rationally be performed only automatically. A sheer arrangement in accordance with relevance, as proposed in WO 99/39466, can only lead to a concatenation of contents without yielding a program which is also observed as a whole by the user. In the solution of sheer relevance, particularly interesting initial contributions are followed by contents which are less interesting to the user.

For this reason, this method will usually not lead to a play sequence and hence to a program whose overall duration will be highly acceptable to each user.

It is therefore an object of the invention to provide a system and a method for generating sequences of audio or video contents, in which available contents are composed to a play sequence which is acceptable to the user.

This object is solved by a system as defined in claim 1 and a method as defined in claim 10. Dependent claims refer to advantageous embodiments of the invention.

The system according to the invention—realized, for example, as a computer system—has storage or access facilities for audio and/or video contents and associated additional data. The contents are preferably stored digitally or compressed by means of known audio or video compression methods. Additional data may comprise a wide variety of information about the content. Examples of such additional data are recording time and date, playback time, type of the audio and video content (for example, news broadcasts, movies, radio plays, and music), theme (for example for news broadcasts: news item about a special event; for music: genre, for example, country, rock, or classic, etc.).

The system comprises selection means for selecting contents and arranging them in a play sequence. The selection means may be preferably realized as a computer program which composes play sequences in the way as described hereinafter, evaluates them and selects the play sequences with the highest evaluation rate.

In a first step, content evaluation rates, or numbers, are determined for individual contents. To determine the content evaluation numbers, the user profile is matched with the additional data characterizing the relevant content.

Subsequently, play sequences consisting of the available and evaluated contents are evaluated by means of a sequence evaluation number. A plurality of different criteria may be taken into account in the sequence evaluation number. On the one hand, the content evaluation numbers of the relevant contents therein are taken into account, for example, as a weighted sum. Moreover, further criteria such as correlation values between the contents, a predetermined duration of the play sequence to be achieved and/or costs incurred when playing back given contents can be taken into account.

A play sequence in accordance with its evaluation number is selected from the play sequences thus evaluated. For example, the sequence having the highest evaluation number can be selected. However, to save computing time, for example, also the first sequence can be selected, which exceeds a predetermined minimum threshold.

When creating sequence evaluation numbers, i.e. evaluating all the play sequences, a sequence which corresponds as a whole to the wishes and preferences of the user and is accordingly accepted by this user is automatically composed, which is in contrast with the sheer evaluation of the relevance of individual audio contents as described in WO 99/39466.

An essential improvement of the invention is the use of correlation values between contents. Two or more contents may be combined with a correlation value which may be preferably both negative and positive. Such a correlation value indicates how the selection of a content for use in the play sequence influences the use of further contents which, as regards contents, are correlated with the first content. A simple example of a negative correlation value would be two contents which, as far as content is concerned, supply complete or substantially identical news items on a theme. When one of these contents is selected, a negative correlation value is used so that, when additionally selecting the second, identical content within the play sequence, the evaluation of the play sequence, i.e. the sequence evaluation number (or the content evaluation number of the second content and hence the sum of the sequence evaluation number) is decreased in value. When both contents thus correspond to the user profile in such a way that they achieve high content evaluation numbers, sequences in which both contents have been selected are nevertheless evaluated with a smaller sequence evaluation number. The probability that the substantially identical contributions both occur in the finally selected play sequence is thus reduced.

An example of a positive correlation value would be two contents, the first of which is, for example, a news broadcast on a special event, such as an earthquake in a given region, and the second content is background information on this theme, for example, a background contribution on earthquakes and their general causes. Without the previous selection of the first content with the current news item, the background contribution in itself is not selected because of a low content evaluation number (little conformity with the user profile for such general information). After the previous selection of the first content, the sequence evaluation number of a sequence, in which also the second content is used, is increased, so that it is more likely to be selected.

Such correlation values may already be comprised in the additional data for given contents, i.e. an indicator for a second content and a, positive or negative, correlation value for this content is stored in the additional data for a first content. However, it is preferred that correlation values are also determined in dependence upon the user profile. Rules for determining correlation values are preferably indicated in the user profile. The selection means reads these rules and uses them in determining the sequence evaluation number.

The sequence evaluation number may be determined as a weighted sum of the content evaluation number. This can be combined with correlation values in that correlation values are added to, or multiplied with, the sum and/or the individual content evaluation numbers of the contents. In the case of addition, “positive” and “negative” correlation values are understood to be positive and negative numbers, respectively, and in the case of multiplication, positive numbers are understood to be factors which are smaller or larger than one.

A desired duration of the play sequence to be generated is predetermined for the system. The system will then attempt to select the contents also with reference to their individually known playing times, such that the predetermined duration is completed. This can be taken into account when determining the sequence evaluation number, so that the determined sequence evaluation number reflects, on the one hand, the degree of content conformity with the user profile and, on the other hand, the degree of conformity with the predetermined playing time.

A further improvement of the invention relates to possible costs which may be incurred when requesting contents. On the one hand, contents may be made available to the user at costs charged by a service provider who also takes over the composition of the sequence. On the other hand, the provider himself may incur costs when requesting data from different sources. The costs incurred when requesting contents may be stored as additional data to contents. When determining content evaluation numbers and/or determining the sequence evaluation number, this information can be used. For example, in the user profile, an upper limit may be indicated for the costs which may be maximally incurred by requesting the relevant contents for each sequence. Likewise, conditions may be given under which offers subject to costs can be requested (for example: in a list of favorite artists, only musical contributions that are current contributions, i.e. not older than, for example, three months).

These and other aspects of the invention are apparent from and will be elucidated with reference to the embodiments described hereinafter.

### In the drawing:

FIG. 1 shows diagrammatically a system for generating audio content sequences.

In the embodiment, a system for generating audio content sequences for a radio program is described. However, the embodiments can also be used without any problem for video contents and for composing TV programs.

A large number of audio contents can be requested from a service provider. These audio contents comprise digital audio files stored locally, for example, in a database. They may also comprise files which are not directly stored with the service provider but can be requested via a computer network, such as the Internet. As explained above, additional data are stored with, or can be requested from, the audio files.

The service provider has a user profile for each user. This user profile may have been created, for example, by the user himself. However, the profile may also have been created automatically on the basis of monitoring the user's consumer behavior so far, or a profile once provided may be constantly updated on the basis of the user's consumer behavior.

The user now requests an audio play sequence from the service provider. An example of such a request would be the daily route of the user to his work, on which route he requests a play sequence of an essentially predetermined length (i.e., for example, the average duration of the trip to his work).

In a computer center of the service provider, a play sequence is composed on the basis of the available user profile from the currently available, stored or retrievable audio contents, which play sequence is transmitted to the user. In this case, the transmission is effected as a “push” transaction of the overall play sequence, i.e. a number of selected audio contents in a fixed sequence without the user actively selecting individual audio contents. However, it would also be possible to provide user interaction, for example, a function for skipping individual contents.

Additional data can be requested together with the individually available audio contents. The additional data comprise some or all of the following information items: type (for example, news, background information, music), keywords to the contents, title, performer, recording time and date, theme, playing time, costs (for the provider and/or the user). Further information may of course be comprised in the additional data.

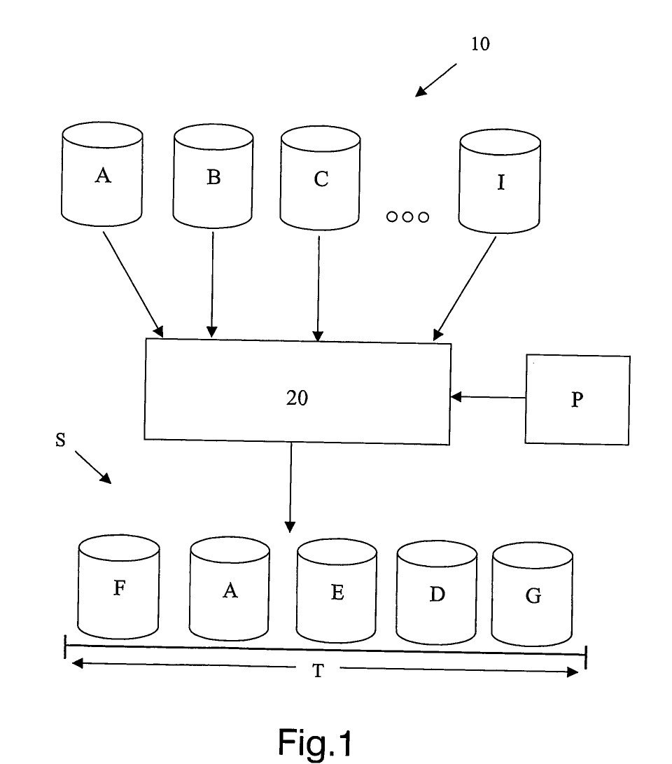

FIG. 1 symbolically shows the system 10 by way of example. Available audio contents are the audio files A-I which are retrievable from a database, with the relevant associated additional data. A computer 20 having an appropriate program accesses the database and can retrieve the audio contents A-I or its additional data.

The computer 20 may alternatively access a stored user profile P. In the example shown, the user profile P comprises the following information:
For contents of the type: news and theme: Europe, a high value of interest, for example, 9 on a scale of 0 to 10.
For type: music and genre: pop, a medium value of interest, for example, 5.
For type: music and performer: Bruce Springsteen, a high value of interest, for example, 9.
Audio contents of the type: news which is older than one week will not be taken into account (value of interest: 0).

As regards contents that are subject to costs, the profile comprises the following general stipulations:
Contents subject to costs have a limit of $1 per sequence.
Contents subject to costs will only be taken into account when there is great conformity with the user profile and when the contents are not older than one month.

The following rules are given for correlations between contents:
(a) Audio contents of the type: news and those of the type: music will be taken into account evenly, i.e. in a 50:50 ratio. Consequently, a negative correlation value is given in the case of deviations from this ratio.
(b) An audio content of the type: music is inserted between two audio contents of the type: news. Consequently, a positive correlation value is given in the selection of a news content, when the previous piece is a music piece, and a negative correlation value will be given in the reverse case.
(c) The audio contents of the type: music within a play sequence should be possibly homogeneous; i.e. preferably performed by the same performer, or at least of the same genre. Contents of the same performers thus acquire a high positive correlation value, while contents of the same genre acquire a (lower) positive correlation value.
(d) Audio contents of the type: news should only be taken into account when the information is not comprised in previously selected audio contents.
(e) Background information, as far as available, should be supplied with the news. Consequently, when selecting an audio content of the type: news and additional selection of an audio content of the type: background information and conformity of the keywords, a high positive correlation value is given.

For the sake of clarity, these rules are formulated here in a natural language. In a concrete realization, a corresponding computer-readable descriptive language with its own grammar is used.

The following audio contents A-I are available for the above-mentioned user profile P in the example of FIG. 1.

| Audio | | | | Costs | | |
|---|---|---|---|---|---|---|
| content | Type | Genre/Theme | Performer | ($) | Source | Keywords |
| A | News | Report on earthquake | | 0 | TV channel | Earthquake; Italy; |
| | | in Italy | | | 7 | Correspondent X |
| B | News | Report on yesterday's | | 0 | TV channel | Earthquake; Italy; |
| | | earthquake in Italy | | | 11 | Correspondent X |
| C | News | Earthquake in Mexico | | 0 | TV channel | Earthquake; Mexico |
| | | 2 weeks ago | | | 2 | |
| D | Background | Earthquakes, general | | 0 | | Earthquake |
| | information | | | | | |
| E | Music | Rock/Pop (old) | Bruce | 0 | | |
| | | | Springsteen | | | |
| F | Music | Rock/Pop (current album) | Bruce | 0.5 | | |
| | | | Springsteen | | | |
| G | Music | Rock/Pop (slightly older) | Bruce | 0.1 | | |
| | | | Springsteen | | | |
| H | Music | Metal (old) | Metallica | 0 | | |
| I | Music | Metal | Metallica | 0.25 | | |

The example above is of course a representation which is simplified for the sake of clarity. In an actual computer implememtation, a larger number of columns (i.e. database fields) may of course be used. Particularly, instead of the approximate date indications in the genre/theme column, which have only been given for descriptive reasons, an exact date indication can be used in a separate column. Above all, however, a considerably larger number, for example, several hundred or thousand contents, will usually be available.

FIG. 1 shows a computer system 20 which makes a selection from the available audio contents by means of an appropriate program run on this computer system and arranges this selection in a play sequence S of a predetermined duration T.

This procedure is performed as follows. Any possible combination of a plurality of audio segments A-I is consecutively considered as a sequence to be tested and an associated sequence evaluation number is determined. For this purpose, a content evaluation number corresponding to the conformity of the relevant additional information with the user profile P is first determined for each audio content A-I. Subsequently, the additional criteria—predetermined duration of the play sequence, costs limit and inputs for using contents that are subject to costs and correlations between the contents—are taken into account. The content evaluation numbers and corresponding numerical events which quantify, for example, the conformity as regards playing time, are weighted and summed.

By way of example, the audio contents A, B and F first acquire high content evaluation numbers because of a great conformity with the user profile. The content E acquires an evaluation which is somewhat lower but is also still high. As a general contribution, contribution D acquires a relatively low evaluation. Contributions H and I acquire low content evaluation numbers because of little conformity with the user profile P. The content evaluation number of contribution C is set to zero because of the input date that has been exceeded.

These content evaluation numbers which are initially supplied are changed once more as follows, on the basis of the predetermined conditions and correlations:
For sequences with a previous selection of content A, the evaluation is clearly reduced (corresponding content, correlation rule (d)) in the case of an additional selection of content C.
For sequences with a selection of one of the contents A or B and subsequent selection of the general contribution D, the sequence evaluation number is clearly increased (correlation rule (e)) on the basis of the background contribution matching the actual contribution.
In sequences in which content E or F has already been selected, the evaluation number is increased (homogeneity) in the case of additional selection of G, but is decreased (no homogeneity) in the case of subsequent selection of H or I.

The rules (a) and (b) for arranging music and news contributions are processed similarly. In this case, those sequences for which the predetermined conditions are fulfilled are given a higher evaluation.

Such an evaluation is performed for different, and preferably all of the possible sequences completing the predetermined duration. The sequences having the highest sequence evaluation number are selected from the evaluated sequences. In the example shown, for example, the sequence F-A-E-D-G could be selected.

A further aspect may be the use of audio contents of the type: commercials. In commercially sponsored programs, the user profile may include a stipulation that a given number of contents of the type: commercials should be comprised in a predetermined unit of time. It is possible to eliminate this rule in return for payment by the user, so that no commercials are provided.

1. A system for generating sequences of audio or video contents (A . . . I), comprising
memory or access facilities for providing contents (A . . . I), with additional data being provided together with the contents (A . . . I),
selection means (20) for composing a play sequence (S), wherein
the selection means (20) access a user profile (P) with selection criteria and determine a content evaluation number for contents (A . . . I) from matching the associated additional data with the selection criteria,
a sequence evaluation number is determined for play sequences (S) composed of available contents (A . . . I),
the content evaluation numbers of the contents (A . . . I) arranged therein are taken into account when determining the sequence evaluation number, and
a play sequence (S) is selected in accordance with its sequence evaluation number.

2. A system as claimed in claim 1, wherein
correlation values between the contents (A . . . I) are taken into account when determining the sequence evaluation number.

3. A system as claimed in claim 2, wherein
the sequence evaluation number is decreased when there is a negative correlation value between two contents (A . . . I), and
the sequence evaluation number is increased when there is a positive correlation value between two contents (A . . . I).

4. A system as claimed in claim, wherein
rules for determining correlation values between contents are indicated in the user profile (P), and
the indicated rules are taken into account when determining the sequence evaluation number.

5. A system as claimed in claim 1, wherein
the sequence evaluation number is determined as a weighted sum of content evaluation numbers.

6. A system as claimed in claim 1, wherein
a predetermined duration (T) of the play sequence (S) and the play duration of the contents (A . . . I) are taken into account when determining the sequence evaluation number.

7. A system as claimed in claim 1, wherein
the additional data comprise costs incurred when requesting the corresponding contents (A . . . I).

8. A system as claimed in claim 1, wherein
the additional data comprise keywords to the content of the corresponding contents (A . . . I).

9. A system as claimed in claim 1, wherein
the selection means comprise one or more computers (20) with a program for realizing the selection function.

10. A method of generating sequences of audio or video contents, wherein
contents (A . . . I) and additional data therefor are made available, and
a content evaluation number is determined for contents (A . . . I) from matching the associated additional data with the selection criteria of a user profile (P), wherein
a play sequence (S) is generated from the available contents (A . . . I) in that a sequence evaluation number is determined for different combinations of contents (A . . . I),
the content evaluation numbers of the contents arranged in the sequence (1) are taken into account when determining the sequence evaluation number, and
a sequence (S) is selected in accordance with its sequence evaluation number.
